(19) United States
(12) Patent Application Publication
(10) Pub. No.: US 2012/0201480 A1
(43) Pub. Date: Aug. 9, 2012

(54) ZIPPER TAPE, PACKAGING BAG WITH ZIPPER TAPE, METHOD FOR PRODUCING PACKAGING BAG WITH ZIPPER TAPE AND PRODUCTION DEVICE THEREFOR

(75) Inventors: Shuichi Goto, Chuo-ku (JP); Ryo Katada, Sodegaura-shi (JP); Mayumi Shimabara, Sodegaura-shi (JP)

(73) Assignee: IDEMITSU UNITECH CO., LTD, TOKYO (JP)

(21) Appl. No.: 13/501,889

(22) PCT Filed: Oct. 13, 2010
(86) PCT No.: PCT/JP2010/067953

§ 371 Date: Apr. 13, 2012

(30) Foreign Application Priority Data
Oct. 14, 2009 (JP) 2009-237529

(51) Int. Cl. B65D 33/16; A44B 19/16; B31B 39/00

(52) U.S. Cl. 383/42; 493/210; 24/399

(57) ABSTRACT

After engagement of a male belt-like member and a female belt-like member are disengaged, a void portion is formed by punching the female belt-like member with a die. The female belt-like member having the void portion and the male belt-like member are re-engaged with each other and fed between a folded base material film that is continuously fed. A male belt-like base and a female belt-like base are heat-sealed. A seal bar heat-seals the base material film to form a bottom seal portion. A side seal bar heat-seals the base material film to form side seal portions. The cutter cuts the base material film in the middle of the side seal portions to produce the packaging bag in which three sides of the bottom seal portion and the side seal portions are heat-sealed.

### TECHNICAL FIELD

The present invention relates to a zipper tape, a packaging bag with the zipper tape, a method for producing the packaging bag with the zipper tape and a production device therefor.

### BACKGROUND ART

A packaging bag with a zipper tape has been used in many fields such as foods, medical products and groceries. A known zipper tape includes a male member and a female member that are engageable with each other.

For producing such a packaging bag with a zipper tape, after thermal compression bonding of the zipper tape to a packaging base material film, thermal compression bonding of the packaging base material film is provided in a direction perpendicular to a longitudinal direction of the zipper tape, thus producing a bag. However, at a portion of thermal compression bonding of the zipper tape to the packaging base material film, a favorable thermal compression bonding of the packaging base material film may not be provided since a resin amount of an engagement portion of the zipper tape is larger than that of other portions. For this reason, a method of producing a packaging bag with a zipper tape that includes removing the engagement portion of the zipper tape corresponding to a thermal compression bonding position of the packaging base material film has been proposed (Patent Literatures 1 to 3).

In Patent Literature 1, an engagement portion of the zipper tape where a male member of a male tape is engaged with a female member of a female tape is cut at a predetermined interval, thereby forming a cut portion in the zipper tape. The zipper tape is fed between two superposed sheets of packaging film and bonded thereto. Subsequently, the packaging film is heat-sealed into a cylindrical shape. The cylindrical packaging film is heat-sealed at the cut portion of the zipper tape in a direction perpendicular to a feeding direction and is cut to produce the packaging bag with the zipper tape.

In Patent Literature 2, the material sheet is formed in a cylindrical shape by superposing both longitudinal ends thereof. A zipper tape provided by an engaged pair of male member and female member is fed between both the longitudinal ends and bonded thereto. Subsequently, the cylindrical material sheet to which the zipper tape is bonded is thermally crush-sealed at an engagement portion of the zipper tape at a predetermined interval. The material sheet is heat-sealed at the crush-sealed portion of the zipper tape in a direction perpendicular to a feeding direction of the material sheet and is cut to produce the packaging bag with the zipper tape.

In Patent Literature 3, an engagement portion where a male chuck is engaged with a female chuck is cut off or removed by heating and compression to form a flat film, thereby forming an engagement-portion-removed portion in the zipper tape. The zipper tape is fed between two superposed sheets of packaging film and bonded thereto. Subsequently, the packaging film is heat-sealed at the engagement-portion-removed portion of the zipper tape in a direction perpendicular to a feeding direction of the packaging film and is cut to produce the packaging bag with the zipper tape.

### CITATION LIST

### Patent Literature(s)

Patent Literature 1 JP-A-2003-276099

Patent Literature 2 JP-A-06-32305

Patent Literature 3 JP-A-06-55674

### SUMMARY OF THE INVENTION

### Problems to be Solved by the Invention

In such an arrangement that the engagement portion of the engaged zipper tape is removed in advance and heat-sealed on the film as described in Patent Literatures 1 and 3, a length of the zipper tape on an inner circumference is different from a length of the zipper tape on an outer circumference. Accordingly, the engagement-portion-removed portion of the male chuck may be shifted from the engagement-portion-removed portion of the female chuck when the zipper tape is delivered for heat-sealing after the engagement portion is removed. Moreover, resin amounts required for respectively forming the male chuck and the female chuck are significantly different. Accordingly, the male chuck and the female chuck may be stretched to different extents by a tension acting thereon in a longitudinal direction when the zipper tape is delivered between the films for heat sealing. Consequently, the engagement-portion-removed portion of the male chuck may be shifted from the engagement-portion-removed portion of the female chuck. In accordance with accumulated misalignment, the engagement-portion-removed portion may be shifted from a cutting position of the film to be cut after heat sealing, so that the packaging bag with the zipper tape may not be sealable.

On the other hand, in such an arrangement that the engagement portion is crushed after the zipper tape is attached to the film as described in Patent Literature 2, temperature setting and control of pressure condition becomes complicated. For instance, the engagement portion may not be sufficiently crushed at a low temperature or the film may have pin holes at a high temperature. Moreover, since the resin of the crushed portion flows out to other portions, such a flow-out to the portions other than the heat seal portion of the film may cause sealing failure or poor appearance. Particularly, when the film includes an aluminum layer, the aluminum layer in the crushed-seal portion is likely to be cracked. Accordingly, the above arrangement is only applicable to a packaging bag without an aluminum layer and the like.

An object of the invention is to provide a zipper tape that is favorably heat-sealed on a base material film at production of a packaging bag and facilitates producing a favorably sealable packaging bag provided with a zipper tape, a packaging bag with the zipper tape, a method for producing the packaging bag with the zipper tape and a production device therefor.

### Means for Solving the Problems

According to an aspect of the invention, a zipper tape includes a male belt-like member having a male engagement portion; a female belt-like member having a female engagement portion engageable with the male engagement portion; and a void portion formed only on the female belt-like member at a predetermined interval in a longitudinal direction, the void portion being formed by removing the female engagement portion from the female belt-like member.

In the above aspect of the invention, the void portion is preferably formed by punching.

According to another aspect of the invention, a packaging bag provided with a zipper tape includes: a packaging-bag film; and the zipper tape according to the above aspect of the invention that is attached to the packaging-bag film, in which the packaging-bag film is superposed on each other and is thermally welded to each other at the void portion of the zipper tape in a direction intersecting a longitudinal direction of the zipper tape.

A method according to still another aspect of the invention is for producing a packaging bag provided with a zipper tape including a male belt-like member having a male engagement portion and a female belt-like member having a female engagement portion engageable with the male engagement portion, the packaging bag being provided by attaching the zipper tape on a packaging-bag film. The method includes: forming a void portion only on the female belt-like member of the zipper tape at a predetermined interval in a longitudinal direction by removing the female engagement portion from the female belt-like member; thermally welding the zipper tape having the void portion on the packaging-bag film; and superposing the packaging bag on each other and thermally welding the superposed packaging bag to each other at the void portion of the zipper tape in a direction intersecting a longitudinal direction of the zipper tape.

A production device according to further aspect of the invention is for producing a packaging bag provided with a zipper tape including a male belt-like member having a male engagement portion and a female belt-like member having a female engagement portion engageable with the male engagement portion, the packaging bag being provided by attaching the zipper tape on a packaging-bag film. The production device includes: a void-portion forming unit that is configured to form a void portion only on the female belt-like member of the zipper tape at a predetermined interval in a longitudinal direction by removing the female engagement portion from the female belt-like member; a zipper tape attaching unit that is configured to thermally weld the zipper tape having the void portion on the packaging-bag film; and a side-seal forming unit that is configured to superpose the packaging-bag film on each other and thermally weld the superposed packaging-bag film to each other at the void portion of the zipper tape in a direction intersecting a longitudinal direction of the zipper tape.

### Effect of the Invention

According to the above aspect of the invention, the void portion is only provided on the female engagement portion at a predetermined interval in the longitudinal direction of the zipper tape. Accordingly, even when the male engagement portion is shifted from the female engagement portion in the longitudinal direction, a situation where a position of a void portion of the male engagement portion is shifted from a position of the void portion of the female engagement portion is not caused, so that a packaging-bag film can be appropriately thermally welded at the position of the void portion. Consequently, a favorable sealing condition of the zipper tape at the thermally welded position is obtainable without damaging the characteristics of the packaging-bag film. Moreover, when the male engagement portion is engaged with the female engagement portion in producing a bag, the male engagement portion having no void portion serves as a guide for engagement, so that secure engagement is easily obtainable and a bag is easily producible.

### BRIEF DESCRIPTION OF DRAWINGS

FIG. 1 is a plan view showing a packaging bag with a zipper tape according to a first exemplary embodiment of the invention.

FIG. 2 is a cross sectional view showing the packaging bag according to the first exemplary embodiment.

FIG. 3 is a perspective view showing a production device of the packaging bag according to the first exemplary embodiment.

FIG. 4 is a perspective view showing a zipper tape member provided with a void portion according to the first exemplary embodiment.

FIG. 5 is a plan view showing a packaging bag according to a second exemplary embodiment of the invention.

FIG. 6 is a perspective view showing a production device of the packaging bag according to the second exemplary embodiment.

FIG. 7 is a perspective view showing that a zipper tape member is provided with a void portion according to the second exemplary embodiment.

FIG. 8 is a perspective view showing a production device of the packaging bag according to a third exemplary embodiment of the invention.

FIG. 9 is a perspective view showing a zipper tape member provided with a void portion according to the third exemplary embodiment.

FIG. 10 is a plan view showing a packaging bag according to a fourth exemplary embodiment of the invention.

FIG. 11 is a cross sectional view showing the packaging bag according to the fourth exemplary embodiment.

FIG. 12 is a perspective view showing a production device of the packaging bag according to the fourth exemplary embodiment.

FIG. 13 is a perspective view showing a production device of a packaging bag according to a fifth exemplary embodiment of the invention.

### DESCRIPTION OF EMBODIMENT(S)

### First Exemplary Embodiment

A first exemplary embodiment of the invention will be described below with reference to the drawings.

In the first exemplary embodiments, a packaging bag with a zipper tape (hereinafter, abbreviated as a “packaging bag”) is exemplified by a packaging bag for packaging various articles such as foods, medicines, medical products and groceries.

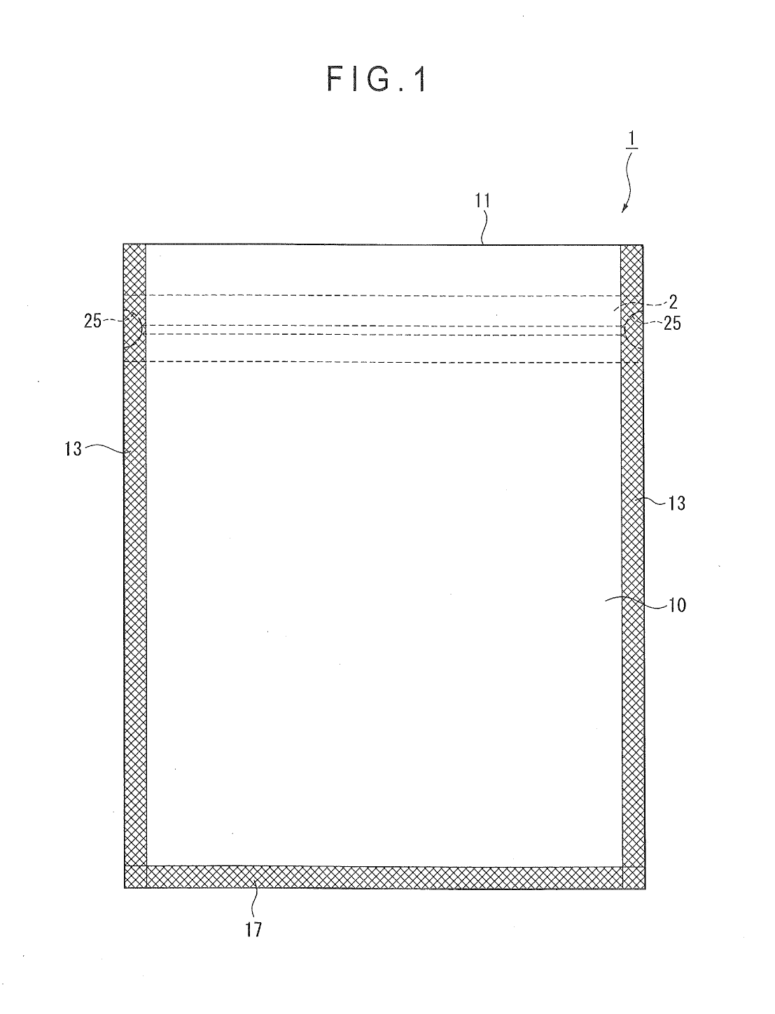

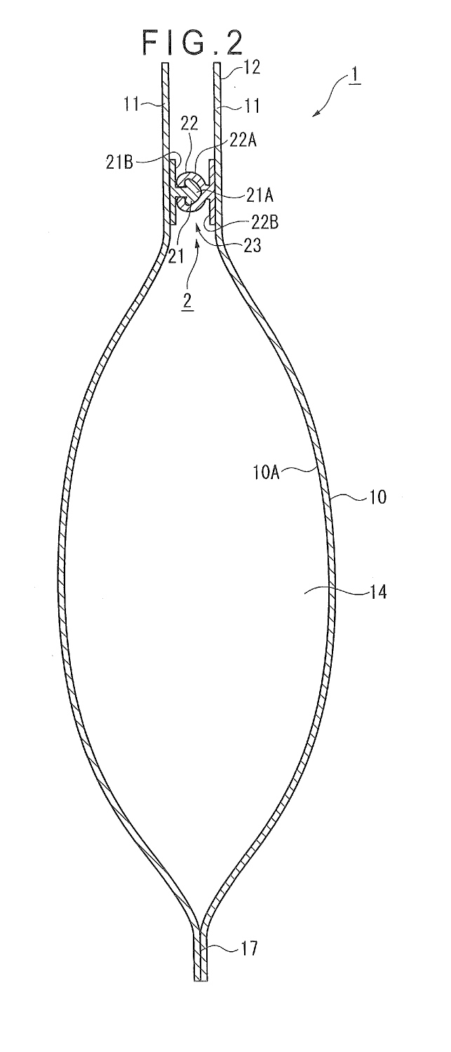

FIG. 1 is a plan view showing a packaging bag according to the first exemplary embodiment. FIG. 2 is a cross sectional view showing the packaging bag according to the first exemplary embodiment.

### Arrangement of Packaging Bag

As shown in FIGS. 1 and 2, a packaging bag 1 includes a sheet of base material film 10 (a packaging-bag film) bonded with each of a male belt-like member 21 (a male tape) having a male engagement portion 21A and a female belt-like member 22 (a female tape) having a female engagement portion 22A. The male engagement portion 21A and the female engagement portion 22A are engageable with each other and provide an engagement portion 23 by engagement thereof. The male belt-like member 21 and the female belt-like member 22 provide a zipper tape 2.

The base material film 10 has base material ends 11 and a bottom seal portion 17 provided by superposing one of the base material ends 11 to the other.

The base material film 10 is heat-sealed to form the side seal portions 13 at both lateral ends. The male belt-like member 21 and the female belt-like member 22 are provided along an opening end opposite to the bottom seal portion 17 in such a manner as to stretch between the side seal portions 13.

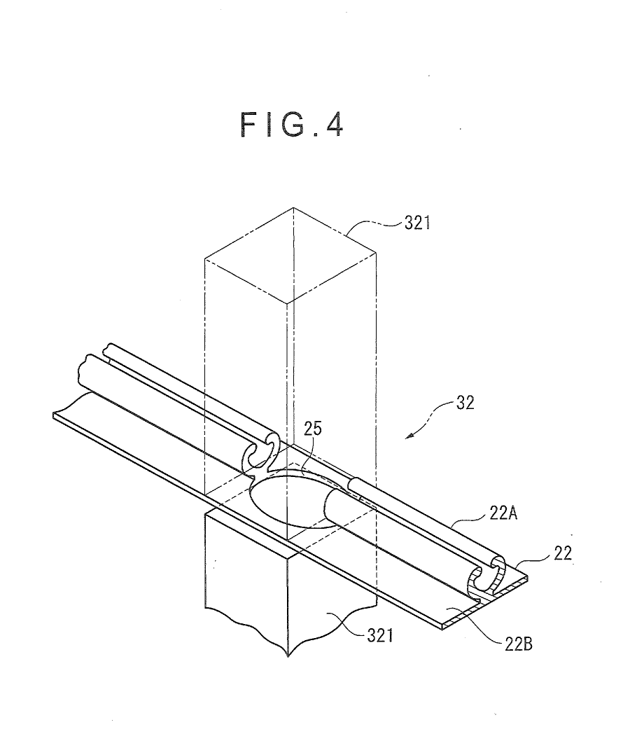

Moreover, a void portion 25 is provided on the female belt-like member 22 located at each of the side seal portions 13 as shown in FIG. 4 (later described). The female engagement portion 22A is substantially removed at the side seal portion 13 by forming the void portion 25. Without unevenness caused by the female engagement portion 22A, a favorable sealing at the side seal portion 13 can be obtained.

The female engagement portion 22A needs to partly extend to the side seal portion 13 with the void portion 25. With this arrangement, contents can be reliably encapsulated in a containing space 14 (later described) after the male engagement portion 21A is engaged with the female engagement portion 22A.

Three sides (i.e., the bottom seal portion 17 and the side seal portions 13) of the base material film 10 are sealed and the male engagement portion 21A and the female engagement portion 22A are engaged with each other, whereby the containing space 14 is formed. The containing space 14 can contain solids, powders, liquids and the like.

The male belt-like member 21 and the female belt-like member 22 are heat-sealed on an inner surface 10A of the base material film 10.

The base material film 10 is not particularly limited as long as being a material for a packaging bag. Preferably, a thickness of the base material film 10 is in a range of 10 μm to 200 μm.

When the thickness of the base material film 10 is less than 10 μm, sealing strength and bag strength may be weakened. On the other hand, when the thickness of the base material film 10 is more than 200 μm, the bag may be difficult to open.

The base material film 10 may have a single-layered structure or a multi-layered structure.

The male belt-like member 21 has an elongated male belt-like base 21B. The male engagement portion 21A is formed substantially in the middle of the male belt-like member 21 in a width direction and along a longitudinal direction in a manner to project from a surface of the male belt-like base 21B facing the containing space 14.

The female belt-like member 22 also has a female belt-like base 22B. The rib-shaped female engagement portion 22A engageable with the male engagement portion 21A projects from a surface of the female belt-like base 22B facing the containing space 14.

A width of each of the male belt-like base 21B and the female belt-like base 22B is preferably in a range of 2 mm to 50 mm, more preferably in a range of 5 mm to 20 mm

When the width of each of the male belt-like base 21B and the female belt-like base 22B is less than 2 mm, a holding portion may become small and difficult to hold. On the other hand, when the width of each of the male belt-like base 21B and the female belt-like base 22B is more than 50 mm, the zipper tape may become large relative to a size of a bag, which is odd.

A thickness of each of the male belt-like base 21B and the female belt-like base 22B is preferably in a range of 50 μm to 500 μm, more preferably in a range of 100 μm to 200 μm.

An opening position of the packaging bag 1 only has to be closer to a top seal portion 12 than the engagement portion 23 provided by the male engagement portion 21A and the female engagement portion 22A. The packaging bag 1 may become easily openable by providing a notch on the side seal portion 13 of the base material film 10 or an opening tape near the male engagement portion 21A and the female engagement portion 22A.

### Production Device of Packaging Bag

Next, a production device of the packaging bag 1 will be described with reference to the drawings.

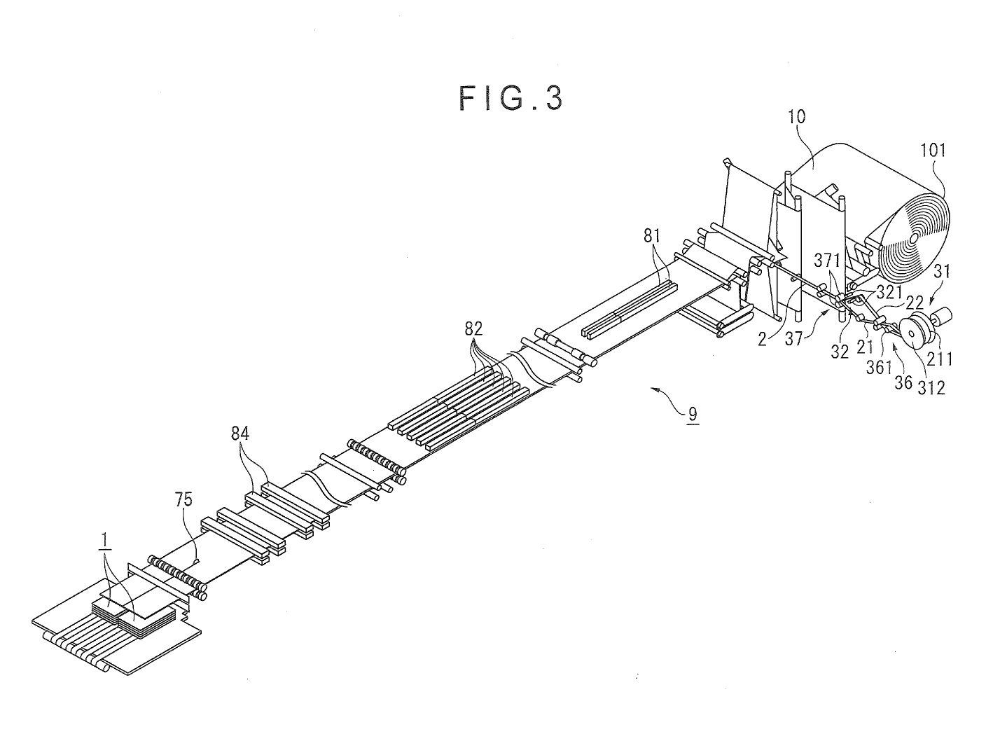

FIG. 3 is a perspective view showing a production device of the packaging bag. FIG. 4 is a perspective view showing that a zipper tape member is provided with a void portion.

A production device 9 is used according to a bag production method by a three- sided sealing. As shown in FIG. 3, the production device 9 includes: a tape feeder 31 that feeds a zipper tape member 211 provided by engaging the male belt-like member 21 and the female belt-like member 22; a disengagement portion 36 that disengages the engagement of the zipper tape member 211; a puncher 32 (lacking-portion forming portion) that punches only the female belt-like member 22 to form the void portion 25 (see FIG. 4); a re-engagement portion 37 that re-engages the male belt-like member 21 and the female belt-like member 22; a zipper-tape attaching device 81 (a zipper-tape attaching portion) that heat-seals the re-engaged zipper tape 2 on the base material film 10 fed from a film-winding roller 101; a seal bar 82 that forms the bottom seal portion 17; a side seal bar 84 that forms the side seal portions 13; and a cutter 75 that cuts the base material film 10 in the middle of the side seal portions 13 to provide the packaging bag 1 in which three sides (i.e., the bottom seal portion 17 and the side seal portions 13) are heat-sealed.

In a next process of the production device 9, a filling device (not shown) that fills the produced packaging bag 1 with contents (not shown) is provided.

As shown in FIG. 3, the tape feeder 31 is detachably provided with a tape-winding roller 312 on which the zipper tape member 211 provided by engaging the male belt-like member 21 and the female belt-like member 22 is rolled, and feeds the zipper tape member 211.

An arrangement for feeding the zipper tape member 211 is not limited to, for instance, an arrangement in which the zipper tape member 211 is continuously fed at a constant speed. Any feeding method such as an intermittent feeding is applicable.

FIG. 3 shows only one of a pair of tape feeders 31 for convenience of descriptions.

The disengagement portion 36 including a rotatable disengagement roller 361 disengages engagement of the male belt-like member 21 and the female belt-like member 22 by separating the male belt-like member 21 and the female belt-like member 22 over an outer circumference of the disengagement roller 361.

As shown in FIG. 4, the puncher 32 includes a die 321. The puncher 32 punches only the female belt-like member 22 among the male belt-like member 21 and the female belt-like member 22 fed from the tape feeder 31 at least at the female engagement portion 22A at the predetermined interval in a feeding direction by using the die 321, thereby forming the void portion 25.

In other words, the void portion 25 is formed at a predetermined interval corresponding to the side seal portion 13.

An arrangement of the puncher 32 is not limited to press processing, but any arrangements such as thermal crushing and cutting for removing at least the female engagement portion 22A is applicable.

The re-engagement portion 37 includes a pair of engagement rollers 371 that re-engage the male belt-like member 21 with the female belt-like member 22 having the void portion 25. The re-engagement portion 37 re-engages the male belt-like member 21 with the female belt-like member 22 by sandwiching the male belt-like member 21 and the female belt-like member 22 between the engagement rollers 371.

The zipper-tape attaching device 81 heat-seals the re-engaged zipper tape 2 on the base material film 10 fed from the film-winding roller 101.

The seal bar 82 forms the bottom seal portion 17 by heat-sealing the base material ends 11 of the base material film 10 on each other.

The side seal bar 84 forms the side seal portion 13 by heat-sealing the base material ends 11 of the base material film 10 on each other.

The cutter 75 cuts the base material film 10 in the middle of the side seal portions 13 to form the packaging bag 1 in which three sides (i.e., the bottom seal portion 17 and the side seal portions 13) are heat-sealed.

### Method for Producing Packaging Bag

Next, a method for producing the packaging bag 1 by using the production device 9 will be described.

The method for producing the packaging bag 1 includes: a tape feeding to feed the male belt-like member 21 and the female belt-like member 22; a punching (void portion formation) to punch only the female belt-like member 22 to form the void portion 25; a zipper tape attachment to attach the zipper tape 2 to the base material film 10; and a bag-making to form the packaging bag 1 of the base material film 10.

In the tape feeding, after the male engagement portion 21A and the female engagement portion 22A in engagement with each other are pulled out from the tape-winding roller 312, the disengagement roller 361 of the disengagement portion 36 disengages the engagement of the male belt-like member 21 and the female belt-like member 22, and the male engagement portion 21A and the female engagement portion 22A are fed for the punching.

In the punching, the die 321 punches only the female engagement portion 22A among the fed male engagement portion 21A and female engagement portion 22A at a predetermined interval to form the void portion 25.

Subsequently, the male engagement portion 21A and female engagement portion 22A are further fed and re-engaged by sandwiching the male belt-like member 21 and the female belt-like member 22 between the engagement rollers 371 of the re-engagement portion 37.

In the zipper tape attachment, the zipper-tape attaching device 81 heat-seals the re-engaged zipper tape 2 on the base material film 10.

Subsequently, in the bag making, the seal bar 82 heat-seals the base material ends 11 of the base material film 10 on each other to form the bottom seal portion 17 and the side seal bar 84 heat-seals the base material ends 11 of the base material film 10 on each other to form the side seal portion 13. The cutter 75 cuts the base material film 10 in the middle of the side seal portions 13 to form the packaging bag 1 in which three sides (i.e., the bottom seal portion 17 and the side seal portions 13) are heat-sealed.

The filling device (not shown) feeds a predetermined amount of contents (not shown) in the produced packaging bag 1 to fill the packaging bag 1 with the contents.

### Advantage of First Exemplary Embodiment

In the above exemplary embodiment, the void portion 25 provided by removing the female engagement portion 22A is provided only on the female belt-like member 22 at a predetermined interval in the longitudinal direction.

With this arrangement, even when the male engagement portion 21A is shifted from the female engagement portion 22A in a longitudinal direction, shifting of the void portion 25 is avoided, so that the side seal portion 13 is formable on the base material film 10 at the position of the void portion 25. Accordingly, a favorable sealing condition of the zipper tape 2 between the side seal portions 13 (thermal-welding position) is obtainable and thickening of the engagement portion 23 is suppressed by the void portion 25 to prevent damage (e.g., tearing an aluminum layer) to characteristics of the base material film 10. Moreover, when the re-engagement portion 37 re-engages the male engagement portion 21A with the female engagement portion 22A, the male engagement portion 21A having no void portion 25 serves as a guide for engagement, so that secure engagement is easily obtainable and a bag is easily producible.

The void portion 25 is formed by punching.

Accordingly, when a part of the female engagement portion 22A located at the periphery of the void portion 25 is crushed when being heat-sealed, most of the part flows into the void portion 25 to prevent thickening the side seal portion 13. Consequently, secure sealing by the zipper tape 2 is obtainable. Additionally, even when a laminated-layer film having an aluminum layer is used as the base material film 10, due to a small difference in thickness, cracking of the aluminum layer is prevented and a bag is favorably produced.

### Second Exemplary Embodiment

Next, a second exemplary embodiment of the invention will be described with reference to the drawings.

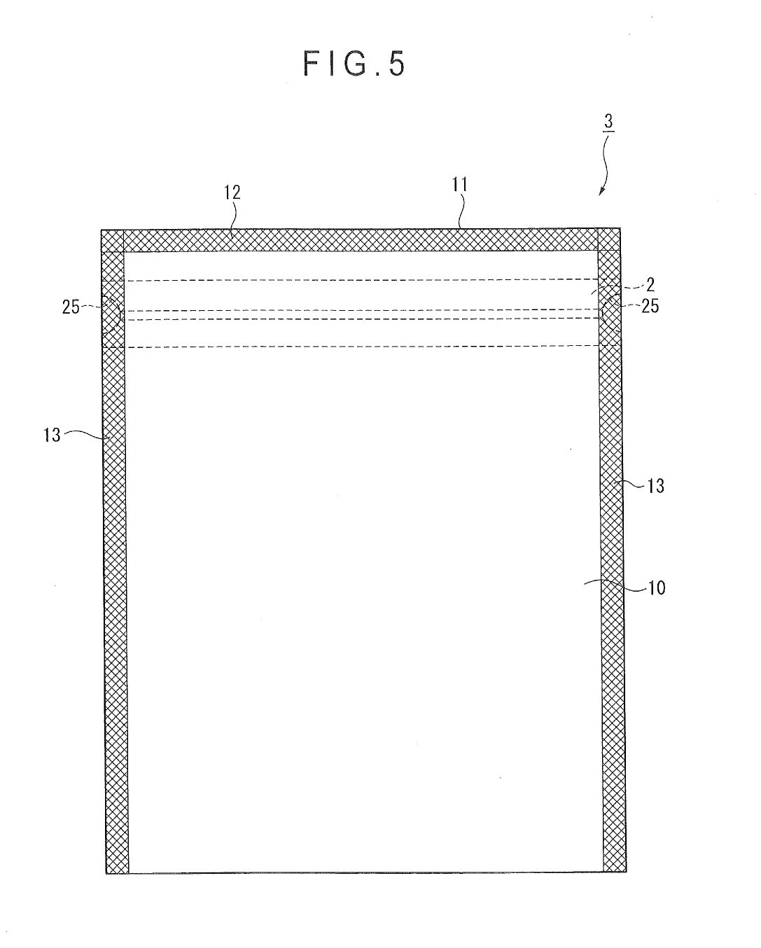

FIG. 5 is a plan view showing a packaging bag according to the second exemplary embodiment.

In the second exemplary embodiment, a packaging bag 3 provided with the top seal portion 12 in place of the bottom seal portion 17 according to the first exemplary embodiment is produced by a vertical-pillow-bag-making method.

In the second exemplary embodiment, the same or similar components as those in the first embodiment are denoted by the same reference symbols and the descriptions thereof will be omitted or simplified.

### Arrangement of Packaging Bag

As shown in FIG. 5, the packaging bag 3 includes a sheet of base material film 10 (the packaging bag film) bonded with each of the male belt-like member 21 (the male tape) having the male engagement portion 21A and the female belt-like member 22 (the female tape) having the female engagement portion 22A. The male engagement portion 21A and the female engagement portion 22A are engageable with each other and provide the engagement portion 23 by engagement thereof. The male belt-like member 21 and the female belt-like member 22 provide a zipper tape 2.

The base material film 10 has the base material ends 11 and the top seal portion 12 provided by superposing one of the base material ends 11 to the other.

The base material film 10 is heat-sealed to form the side seal portions 13 at both lateral ends. The male belt-like member 21 and the female belt-like member 22 are provided along the top seal portion 12 in such a manner as to stretch between the side seal portions 13.

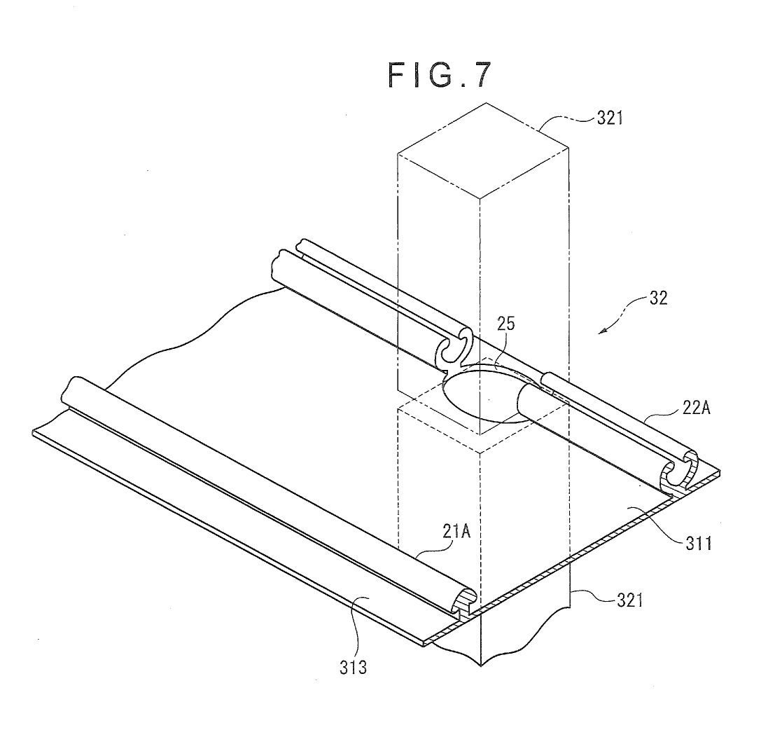

Moreover, the void portion 25 is provided on the female belt-like member 22 located at the side seal portion 13 as shown in FIG. 7 (later described).

Three sides (i.e., the top seal portion 12 and the side seal portions 13) of the base material film 10 are sealed to form the containing space 14. The containing space 14 can contain solids, powders, liquids and the like.

The male belt-like member 21 and the female belt-like member 22 are heat-sealed on an inner surface 10A of the base material film 10.

An opening position of the packaging bag 3 only has to be closer to the top seal portion 12 than the engagement portion 23 provided by the male engagement portion 21A and the female engagement portion 22A. The packaging bag 3 may become easily openable by providing a notch on the side seal portion 13 of the base material film 10 or an opening tape near the male engagement portion 21A and the female engagement portion 22A.

### Production Device of Packaging Bag

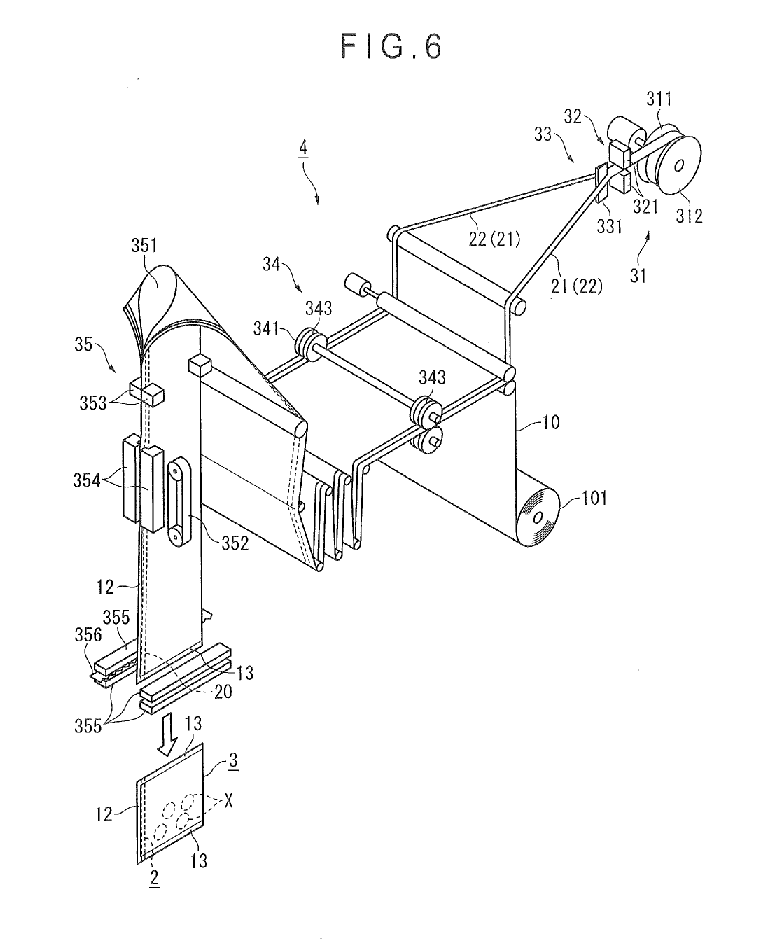

FIG. 6 is a perspective view showing a production device of the packaging bag according to the second exemplary embodiment. FIG. 7 is a perspective view showing a zipper tape member provided with a void portion.

As shown in FIG. 6, a so-called vertical-pillow-bag production device 4 includes: the tape feeder 31 that feeds a zipper tape member 311; the puncher 32 that punches the zipper tape member 311 to form the void portion 25 (see FIG. 7); a separator 33 that separates the zipper tape member 311 into the male belt-like member 21 and the female belt-like member 22; a zipper-tape attaching device 34 that attaches the male belt-like member 21 and the female belt-like member 22 to the base material film 10; and a bag-making device 35 that produces the packaging bag 3 of the base material film 10.

As shown in FIG. 7, the zipper tape member 311 is provided by an elongated belt-like tape 313 and a pair of the male engagement portion 21A and the female engagement portion 22A projecting in a rib-like shape from the tape 313 along a longitudinal direction. In other words, the zipper tape member 311 is shaped such that the male belt-like member 21 and the female belt-like member 22 are juxtaposed to each other in a width direction on a surface of the zipper tape member 311.

As shown in FIG. 6, the tape feeder 31 is detachably provided with the tape-winding roller 312 on which the zipper tape member 311 is rolled, and feeds the zipper tape member 311.

Any method of feeding of the zipper tape member 311 is applicable. The method may include not only continuously feeding the zipper tape member 311 at a constant speed, but also intermittently feeding the zipper tape member 311.

As shown in FIG. 7, the puncher 32 includes the die 321. The puncher 32 punches the zipper tape member 311 fed from the tape feeder 31 only at the female engagement portion 22A at a predetermined interval in a feeding direction by using the die 321, thereby forming the void portion 25.

In other words, the void portion 25 is formed at a predetermined interval correspondingly to the side seal portion 13.

An arrangement of the puncher 32 is not limited to press working, but any arrangements for removing only the female engagement portion 22A is applicable. The process using the puncher 32 may follow a process using the separator 33 (later described). Specifically, the void portion 25 may be formed only in the female engagement portion 22A using the puncher 32 in the same manner as in the first exemplary embodiment after the zipper tape member 311 is cut into the male engagement portion 21A and the female engagement portion 22A using the separator 33.

As shown in FIG. 6, the separator 33 includes a cutting member 331.

The separator 33 cuts the zipper tape member 311 in the middle of the male engagement portion 21A and the female engagement portion 22A in a width direction using the cutting member 331, the zipper tape member 311 having the void portion 25 formed by the puncher 32 while being fed from the tape feeder 31. Thus, the zipper tape member 311 is separated into the male belt-like member 21 having the male engagement portion 21A and the female belt-like member 22 having the female engagement portion 22A.

The cutting member 331 may be a fixed blade or a rotary blade.

Cutting the zipper tape member 311 in the middle of the male engagement portion 21A and the female engagement portion 22A in a width direction is suitable in terms of positioning the male belt-like member 21 and the female belt-like member 22 in the following process.

As shown in FIG. 6, the zipper-tape attaching device 34 includes a positioning guide portion 341 and a first heat seal portion (not shown).

The zipper-tape attaching device 34 positions the male belt-like member 21 and the female belt-like member 22 by the positioning guide portion 341 at both sides and along both ends in the feeding direction (longitudinal direction) of the base material film 10 fed from the film-winding roller 101. The zipper-tape attaching device 34 heat-seals the positioned male belt-like member 21 and female belt-like member 22 on the base material film 10 by the first heat seal portion.

An arrangement of the positioning guide portion 341 is not limited to the arrangement with rollers 343 as shown in FIG. 6, in which the rollers 343 respectively have a recessed periphery corresponding to the male engagement portion 21A and the female engagement portion 22A. Any arrangement is applicable as long as the positioning guide portion 341 can position the male belt-like member 21 and the female belt-like member 22 while the base material film 10, the male belt-like member 21 and the female belt-like member 22 are fed.

A method of attaching the male belt-like member 21 and the female belt-like member 22 on the base material film 10 is not limited to the heat-seal method. Various methods such as a welding method by ultrasonic waves and an attachment method by an adhesive or the like are applicable.

As shown in FIG. 6, the bag-making device 35 includes: a cylindrical former 351 around which the base material film 10 welded with the male belt-like member 21 and the female belt-like member 22 (i.e., the zipper tape 2) is wrapped; a feed belt 352 disposed on lateral sides of the cylindrical former 351; an engagement member 353 that engages the male engagement portion 21A with the female engagement portion 22A; a seal bar 354 that forms the top seal portion 12 by heat-sealing both lateral sides of the base material film 10 on each other; a side seal bar 355 (a side-seal forming portion) that forms the side seal portions 13 by heat-sealing; and a cutter 356 that cuts the base material film 10 at the side seal portion 13 to provide the packaging bag 3.

The cylindrical former 351 is formed hollow. The packaging bag 3 is filled with contents X through an inner space of the cylindrical former 351.

The base material film 10 is wrapped around the cylindrical former 351 and both the lateral sides of the base material film 10 are superposed on each other. Accordingly, the male engagement portion 21A and the female engagement portion 22A face each other. The engagement member 353 engages the male engagement portion 21A with the female engagement portion 22A.

### Method for Producing Packaging Bag

Next, a method for producing the packaging bag 3 by using the production device 4 will be described.

The method for producing the packaging bag 3 includes: a tape feeding to feed the zipper tape member 311; a punching (void portion formation) to punch only the female belt-like member 22 of the zipper tape member 311 to form the void portion 25; a zipper tape attachment to attach the zipper tape 2 to the base material film 10; and a bag-making to form the packaging bag 3 of the base material film 10.

In the tape feeding, the zipper tape member 311 is pulled from the tape-winding roller 312 and is transferred to the punching.

In the punching, the die 321 punches only the female belt-like member 22 of the fed zipper tape member 311 at a predetermined interval to form the void portion 25.

Subsequently, the fed and punched zipper tape member 311 is separated into the male belt-like member 21 and the female belt-like member 22 using the cutting member 331.

In the zipper tape attachment, the separated male belt-like member 21 and the female belt-like member 22 are positioned by the positioning guide portion 341 such that the male belt-like base 21B and the female belt-like base 22B are respectively positioned on both the lateral sides of the fed base material film 10. Here, the first heal seal portion heat-seals the positioned male belt-like member 21 and female belt-like member 22 on the base material film 10.

In the following bag-making, the base material film 10 is wrapped around the cylindrical former 351 and the male engagement portion 21A and the female engagement portion 22A are engaged with each other by the engagement member 353. Subsequently, the seal bar 354 heat-seals superposed ends of the base material film 10 on each other to form the top seal portion 12. In the following side-seal formation, the side seal bar 355 heat-seals the base material film 10 in a direction perpendicular to the feeding direction of the base material film 10 to form a first side seal portion 13 for producing the packaging bag 3.

Here, the heat-sealing position corresponds to the void portion 25 previously formed on the female belt-like member 22. In heat-sealing, the side seal bar 355 also heat-seals a part of the female engagement portion 22A in order to provide a secure sealing condition by the zipper tape 2, in which the part is located at an edge of the void portion 25. The female engagement portion 22A crushed by heat-sealing mostly flows into the adjacent void portion 25, so that thickening of the side seal portion 13 is prevented. In other words, a resin of the crushed part flows into the void portion 25 formed by punching on the condition that the part of the female engagement portion 22A is crushed in order to obtain the secure sealing condition. This arrangement prevents increase in a difference between a portion of the side seal portion 13 with the zipper tape 2 and a portion thereof without the zipper tape 2.

After the filling device (not shown) fills the produced packaging bag 3 with a predetermined amount of contents X, the side seal bar 355 heat-seals the base material film 10 in a direction perpendicular to the feeding direction of the base material film 10.

Further, the contents X is enclosed by forming a second side seal portion 13. The base material film 10 is cut in the middle of the side seal portions 13. Thus, the packaging bag 3 is filled with the contents X.

### Advantage of Second Exemplary Embodiment

In the second exemplary embodiment, the zipper tape member 311 is provided by the male belt-like member 21 and the female belt-like member 22 that are juxtaposed in the width direction and are integrated, and the void portion 25 is provided only on the female belt-like member 22 of the zipper tape member 311 at a predetermined interval in the longitudinal direction of the female belt-like member 22.

Accordingly, in the same manner as in the first exemplary embodiment, a favorable sealing condition of the zipper tape 2 between the side seal portions 13 (thermal welding position) is obtainable and the thickness of the side seal portion 13 is decreased by the removed amount by the void portion 25 to prevent damage (e.g., tearing an aluminum layer) to characteristics of the base material film 10. Moreover, in the bag-making, the male engagement portion 21A having no void portion 25 serves as a guide for engagement, so that secure engagement between the male engagement portion 21A and the female engagement portion 22A is easily obtainable and a bag is easily producible.

The void portion 25 is formed on the zipper tape member 311 that is an integrated body before the zipper tape member 311 is separated into separate bodies of the male belt-like member 21 and the female belt-like member 22.

Accordingly, since the void portion 25 can be formed on the integrated body wider than the separate bodies, the void portion 25 is easily formed without disadvantages such as cutting of the female belt-like member 22 by a stress applied during the process.

The zipper tape member 311 is cut by the cutting member 331 to be separated into the male belt-like member 21 and the female belt-like member 22.

Accordingly, a tension acting on the male belt-like member 21 and the female belt-like member 22 is relatively small, so that disadvantages such as stretch of the male belt-like member 21 and the female belt-like member 22 can be avoided even when the zipper tape member 311 is cut after the formation of the void portion 25. Accordingly, the void portion 25 provided on the female belt-like member 22 is not shifted from the side seal portion 13, so that appropriate heat-sealing is possible at the void portion 25.

### Third Exemplary Embodiment

Next, a third exemplary embodiment of the invention will be described with reference to the drawings.

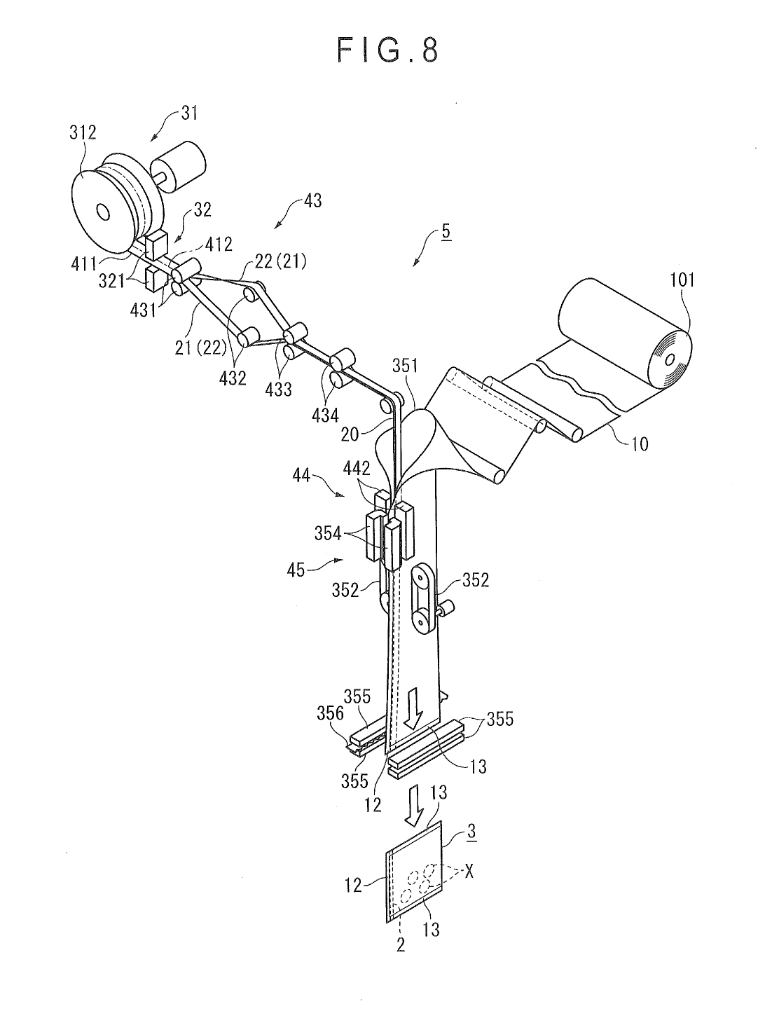

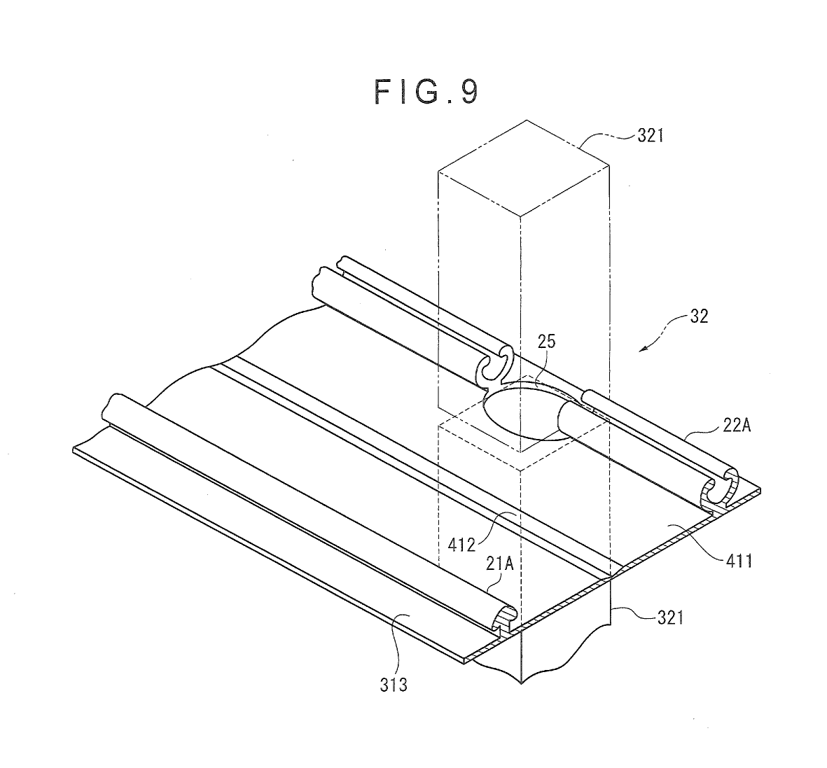

FIG. 8 is a perspective view showing a production device of the packaging bag according to the third exemplary embodiment. FIG. 9 is a perspective view showing a zipper tape member provided with a void portion.

The third exemplary embodiment also relates to a vertical-pillow-bag-making method similar to that in the second exemplary embodiment. In the third exemplary embodiment, a zipper tape member 411 is torn in half in a width direction whereas the zipper tape member 311 is cut by the cutting member 331 in the second exemplary embodiment.

In the third exemplary embodiment, the same or similar components as those in the above embodiments are denoted by the same reference symbols and the descriptions thereof will be omitted or simplified.

### Production Device of Packaging Bag

In a production device 5 according to the third exemplary embodiment, a separator 43 and a zipper-tape attaching device 44 that heat-seals the zipper tape 2 provided by the separator 43 on the base material film 10 are used. The separator 43 is used in place of the separator 33 in the second exemplary embodiment. The zipper-tape attaching device 44 is used in place of the zipper-tape attaching device 34 in the second exemplary embodiment.

As shown in FIG. 9, the zipper tape member 411 has a thin portion 412 in a longitudinal direction between the male engagement portion 21A and the female engagement portion 22A of the zipper tape member 311 according to the second exemplary embodiment. In place of the thin portion 412, a perforated portion that is formed in a cutting dotted line may be provided. The thin portion 412 and the perforated portion may be provided together.

The separator 43 separates the zipper tape member 411 in a manner to tear the zipper tape member 411 along the thin portion 412.

Specifically, as shown in FIG. 8, the separator 43 includes: a pair of holding rollers 431 that hold the zipper tape member 411 therebetween; tearing rollers 432 that are provided on the downstream side in the feeding direction of the zipper tape member 411, the separated male belt-like member 21 and the female belt-like member 22 being supported by the tearing rollers 432; positioning rollers 433 that are provided on the downstream side of the tearing rollers 432 and bias the male belt-like member 21 and the female belt-like member 22 so as to face each other; and a pair of engagement rollers 434 that are provided on the downstream side of the positioning rollers 433 and engage the male engagement portion 21A with the female engagement portion 22A.

The tearing rollers 432 are provided on both sides in the longitudinal direction of the zipper tape member 411 and are spaced from each other in a thickness direction such that the male belt-like member 21 and the female belt-like member 22 are torn apart along the thin portion 412 by a tension acting in opposite directions.

The tearing rollers 432 invert either one of the torn male belt-like member 21 and female belt-like member 22. The male belt-like member 21 and the female belt-like member 22 are supported by the tearing rollers 432 such that the male engagement portion 21A and the female engagement portion 22A face each other.

Here, such an arrangement for allowing the male engagement portion 21A and the female engagement portion 22A to face each other is not limited to the arrangement of inverting only one of the male belt-like member 21 and the female belt-like member 22. Both the male engagement portion 21A and the female engagement portion 22A may be respectively twisted by 90 degrees to opposite directions to face each other. With this arrangement, both the male belt-like member 21 and the female belt-like member 22 are similarly twisted, so that occurrence of difference between feeding condition of the male belt-like member 21 and feeding condition of the female belt-like member 22 is reliably avoidable and the zipper tape 2 is favorably attachable.

The male belt-like member 21 and the female belt-like member 22 without engagement may be respectively attached on the base material film 10 by the zipper-tape attaching device 44 in the following process.

Similarly to the second exemplary embodiment, the void portion 25 may be provided only on the female belt-like member 22 after the zipper tape member is separated into the male belt-like member 21 and the female belt-like member 22 by the separator 43.

The zipper-tape attaching device 44 includes a second heat seal portion 442.

The zipper-tape attaching device 44 interposes the zipper tape 2 fed from the separator 43 between the superposed lateral sides of the base material film 10 in the feeding direction, in which the base material film 10 is fed from the film-winding roller 101 and wrapped around the cylindrical former 351 of the bag-making device 45. Subsequently, the second heat seal portion 442 heat-seals the zipper tape 2 on the base material film 10.

Similarly to the zipper-tape attaching device 34, the zipper tape 2 can be attached by various methods such as a welding by ultrasonic waves and an attachment by an adhesive or the like in addition to the heat-seal method.

The bag-making device 45 includes: the cylindrical former 351 around which the base material film 10 is wrapped; the feed belt 352 disposed on the lateral sides of the cylindrical former 351; the seal bar 354 that forms the top seal portion 12 by heat-sealing both the lateral sides of the base material film 10 on each other; the side seal bar 355 that forms the side seal portions 13 by heat-sealing; and the cutter 356 that cuts the base material film 10 at the side seal portion 13 to provide the packaging bag 3.

### Method for Producing Packaging Bag

Next, a method for producing the packaging bag 3 by using the production device 5 will be described.

In the third exemplary embodiment, the fed and punched zipper tape member 411 is separated into the male belt-like member 21 and the female belt-like member 22 to be torn along the thin portion 412 in the separating process. The male engagement portion 21A and the female engagement portion 22A are engaged with each other to provide the zipper tape 2.

Similarly to the second exemplary embodiment, in the attaching process, the zipper tape 2 is attached on both the lateral sides of the base material film 10 wrapped around the cylindrical former 351 to produce a bag.

### Advantage of Third Exemplary Embodiment

In the third exemplary embodiment, after the void portion 25 is provided only on the female belt-like member 22 of the zipper tape member 411, the zipper tape member 411 is separated into the male belt-like member 21 and the female belt-like member 22. Accordingly, similarly to the second exemplary embodiment, a favorable sealing condition is easily obtained without damaging the characteristics of the base material film 10.

The separator 43 is arranged to include the tearing rollers 432 that tears the zipper tape member 411 along the thin portion 412. Accordingly, as compared with the arrangement using the cutting member 331 in the second exemplary embodiment, no maintenance requiring parts replacement is necessary, thereby improving productivity.

### Fourth Exemplary Embodiment

Next, a fourth exemplary embodiment of the invention will be described with reference to the drawings.

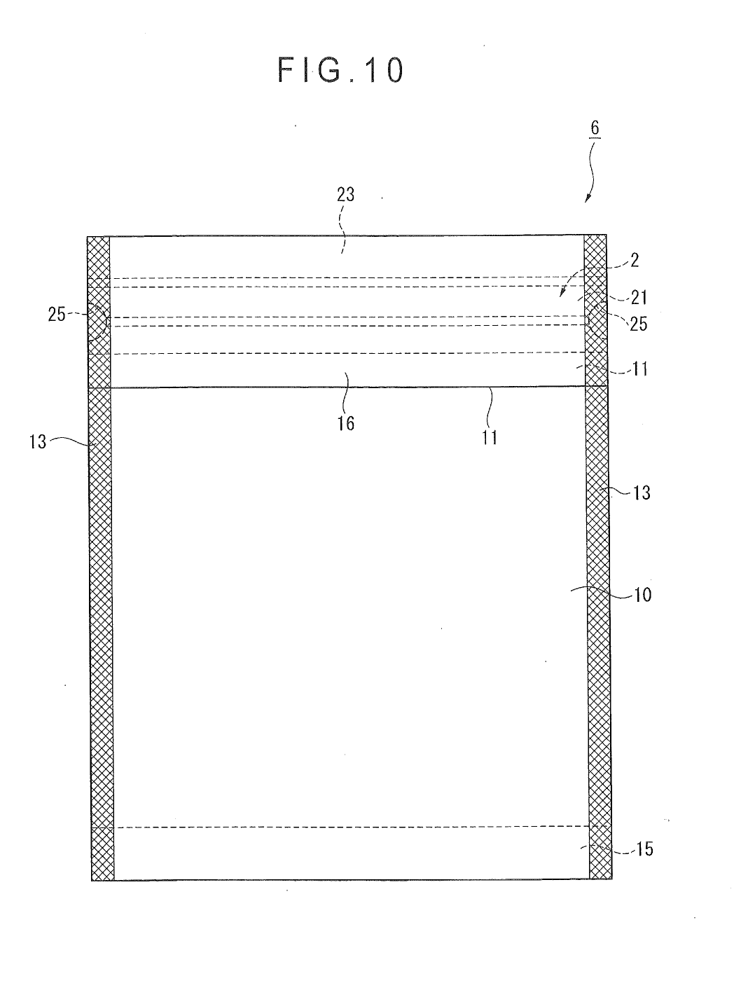

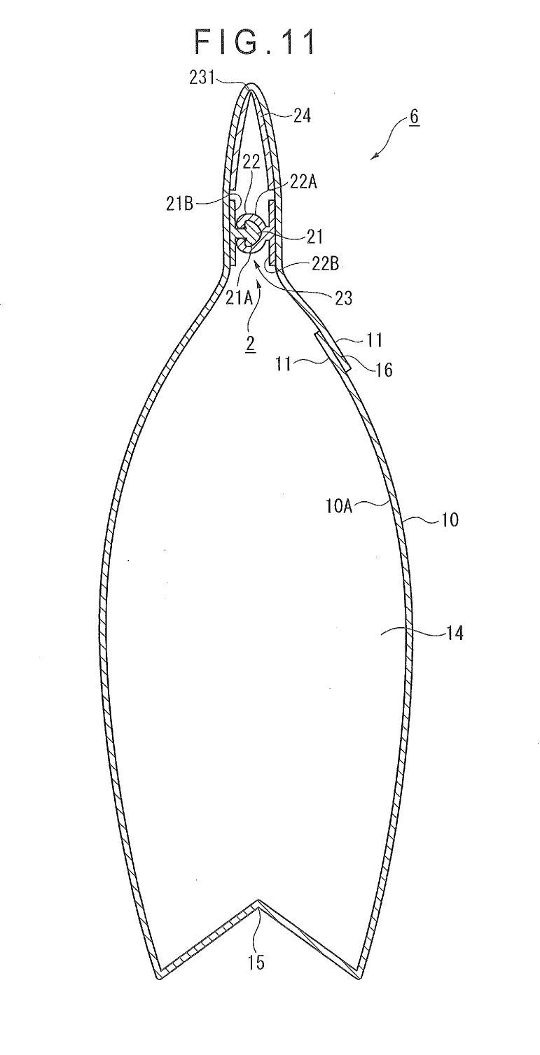

FIG. 10 is a plan view showing a packaging bag according to the fourth exemplary embodiment. FIG. 11 is a cross sectional view showing a packaging bag according to the fourth exemplary embodiment.

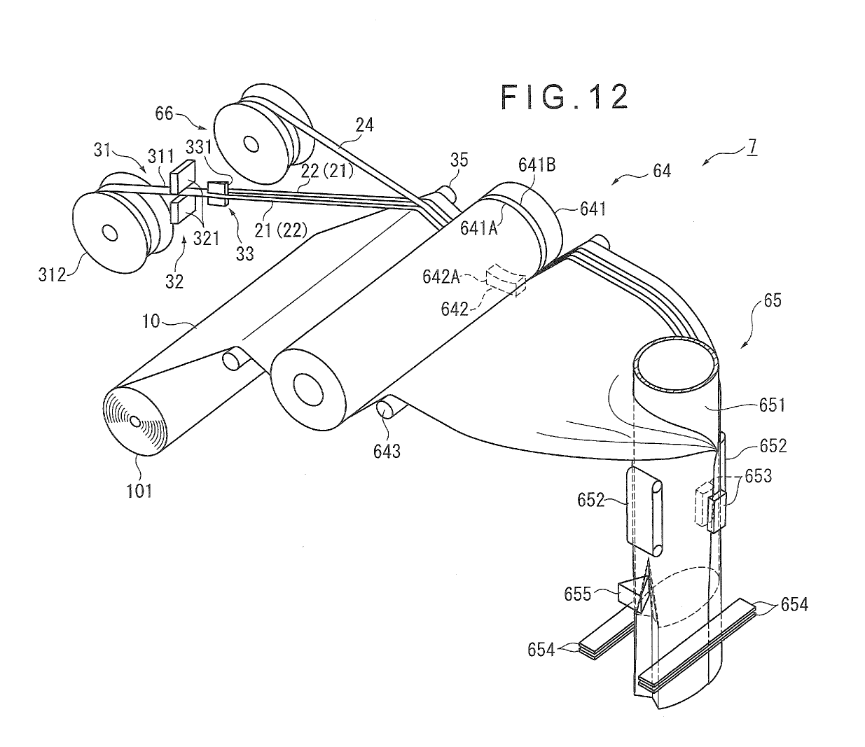

In the fourth exemplary embodiment, as shown in FIG. 12 below, a zipper-tape attaching device 64 provided with a rotary drum 641 is used in place of the bag-making device 35 provided with the cylindrical former 351 in the second exemplary embodiment.

In the fourth exemplary embodiment, the same or similar components as those in the above embodiments are denoted by the same reference symbols and the descriptions thereof will be omitted or simplified.

### Arrangement of Packaging Bag

As shown in FIGS. 10 and 11, in the packaging bag 6, the male belt-like member 21 having the male engagement portion 21A, the female belt-like member 22 having the female engagement portion 22A, and a bendable member 24 having a bendable portion 231 in the middle of a width direction are separately bonded to a sheet of base material film 10 at a predetermined interval to each other. The bendable member 24 is provided between the male belt-like member 21 and the female belt-like member 22. The bent portion 231 is bendable for engaging the male engagement portion 21A with the female engagement portion 22A. The male belt-like member 21 and the female belt-like member 22 provide the zipper tape 2.

The base material film 10 has base material ends 11 and a backlining portion 16 provided by superposing one of the base material ends 11 to the other.

The base material film 10 is heat-sealed to form the side seal portions 13 at both lateral ends. The male belt-like member 21 and the female belt-like member 22 are provided in a manner so as to bridge the side seal portions 13.

The containing space 14 is formed by the backlining portion 16 and the side seal portions 13 in the base material film 10. The gusset 15 is formed on the bottom of the base material film 10.

### Production Device of Packaging Bag

Next, a production device of the packaging bag 6 will be described with reference to the drawings.

FIG. 12 is a perspective view showing a production device of the packaging bag according to the fourth exemplary embodiment.

As shown in FIG. 12, a production device 7 includes: the tape feeder 31 that feeds the zipper tape member 311; the puncher 32 that punches only the female belt-like member 22 of the zipper tape member 311 to form the void portion 25; the separator 33 that separates the zipper tape member 311 into the male belt-like member 21 and the female belt-like member 22; the zipper-tape attaching device 64 that attaches the male belt-like member 21 and the female belt-like member 22 on the base material film 10; a bag-making device 65 that forms the packaging bag 6 of the base material film 10, and a bendable member feeder 66 that feeds the bendable member 24. A guide roller is denoted by the reference number 643.

Also in the fourth exemplary embodiment, the void portion 25 may be provided only on the female belt-like member 22 that is obtained after division by the separator 33.

As shown in FIG. 12, the zipper-tape attaching device 64 includes the substantially cylindrical rotary drum 641 that is rotated by a driving source (not shown), and a seal bar 642 having a weld surface 642A curved to conform with a circumferential shape of the rotary drum 641.

A first groove 641A that introduces the male engagement portion 21A, and a second groove 641B that introduces the female engagement portion 22A are provided along a circumferential direction of the rotary drum 641.

The groove 641A has a substantially rectangular cross section large enough to receive the male belt-like member 21. The groove 641B has a substantially rectangular cross section large enough to receive the female belt-like member 22. A bottom surface of each of the grooves 641A and 641B is substantially parallel to the periphery of the rotary drum 641. The opposing lateral surfaces of the groove 641A are formed to have substantially the same length as a projecting length of the male belt-like member 21 and the opposing lateral surfaces of the groove 641B are formed to have substantially the same length as a projecting length of the female belt-like member 22.

The first groove 641A and the second groove 641B are respectively arranged to introduce the male engagement portion 21A and the female engagement portion 22A such that the bendable member 24 is provided between the male belt-like base 21B and the female belt-like base 22B at a predetermined interval to each other and the male engagement portion 21A and the female engagement portion 22A are engageable with each other by the bendable portion 231 of the bendable member 24.

The rotary drum 641 is preferably supported by a support such that an axial direction of the rotary drum 641 becomes horizontal. This arrangement aims for easily positioning the male belt-like member 21 and the female belt-like member 22 to a predetermined position on the base material film 10.

The bag-making device 65 includes: a cylindrical former 651 around which the base material film 10 welded with the zipper tape 2 is wrapped; a feed belt 652 disposed on lateral sides of the cylindrical former 652; a seal bar 653 that forms the backlining portion by fusing both the base material ends 11 of the base material film 10 to each other; a side seal bar 654 that forms the side seal portions 13; a triangle plate 655 that forms the gusset 15; and a cutter (not shown) that cut the base material film 10 at the side seal portion 13 to provide the packaging bag 6.

### Method for Producing Packaging Bag

A method for producing the packaging bag 6 by using the production device 7 will be described.

The method for producing the packaging bag 6 includes: a tape feeding to feed the zipper tape member 311; a punching to punch only the female belt-like member 22 of the zipper tape member 311 to form the void portion 25; a separating to separate the zipper tape member 311 into the male belt-like member 21 and the female belt-like member 22, an attaching to attach the zipper tape 2 to the base material film 10; and a bag-making to form the packaging bag 6 of the base material film 10.

In the tape feeding, the zipper tape member 311 is pulled from the tape-winding roller 312. In the punching, the die 321 punches only the female belt-like member 22 of the fed zipper tape member 311 at a predetermined interval to form the void portion 25. Subsequently, in the separating, the zipper tape member 311 is separated into the male belt-like member 21 and the female belt-like member 22 by the cutting member 331.

The male belt-like member 21 and the female belt-like member 22 are transferred to the zipper-tape attaching device 64 while being superposed on the base material film 10 pulled from the film-winding roller 101. For superposing the male belt-like member 21 and the female belt-like member 22 on the base material film 10, the bendable member 24 is provided between the male belt-like base 21B and the female belt-like base 22B at a predetermined interval to each other. The bendable member 24, the male belt-like member 21 and the female belt-like member 22 are transferred to the zipper-tape attaching device 64 while being superposed on the base material film 10.

In the attaching, with the zipper-tape attaching device 64, the male belt-like member 21, the female belt-like member 22, the bendable member 24 and the base material film 10 are continuously fed by the rotation of the rotary drum 641 while the male belt-like member 21, the female belt-like member 22 and the bendable member 24 are superposed on the base material film 10 and the male belt-like base 21B and the female belt-like base 22B are introduced by the grooves 641A and 641B of the rotary drum 641.

Simultaneously, the male belt-like member 21, the female belt-like member 22 and the bendable member 24 are bonded to a sheet of the base material film 10 by pressing the base material film 10 with the seal bar 642 having the weld surface 642A curved to conform with the periphery of the rotary drum 641.

A rotation speed of the rotary drum 641 for continuously feeding is preferably in a range of 5 m/min to 40 m/min, more preferably in a range of 10 m/min to 30 m/min

When the speed is less than 5 m/min, productivity may be reduced to increase costs. On the other hand, when the speed exceeds 40 m/min, sealing strength may become unstable.

The base material film 10 to which the zipper tape 2 is welded is fed to the bag-bag-making device 65.

In the bag-making, the base material film 10 is fed downward by the feed belt 652 while being wrapped around the cylindrical former 651. Here, the base material film 10 is fed such that the void portion 25 and the side seal portion 13 are aligned. While the backlining portion is formed by the seal bar 653, the gusset 15 is formed at a position corresponding to the bottom of the bag by the triangle plate 655.

The side seal bar 654 forms the first side seal portion 13. After the contents are fed through the inner space of the cylindrical former 651, the side seal bar 654 forms the second side seal portions 13. The packaging bag 6 is obtained by cutting the base material film 10 at the side seal portion 13.

### Advantage of Fourth Exemplary Embodiment

Also in the fourth exemplary embodiment, after the void portion 25 is provided only on the female belt-like member 22 of the zipper tape member 311, the zipper tape member 311 is separated into the male belt-like member 21 and the female belt-like member 22. Accordingly, similarly to the second and third exemplary embodiments, a favorable sealing condition of the zipper tape 2 including a sealing condition at the side seal portion 13 is easily obtained without damaging the characteristics of the base material film 10. Moreover, secure engagement between the male engagement portion 21A and the female engagement portion 22A is easily obtainable and a bag is easily producible. Since the void portion 25 is formed on a wider member, the void portion 25 is easily formed.

Since the zipper tape member 311 is separated by the cutting member 331, the void portion 25 provided on the female belt-like member 22 is not shifted from the side seal portion 13, so that appropriate heat-sealing is possible at the void portion 25.

### Fifth Exemplary Embodiment

Next, a fifth exemplary embodiment of the invention will be described with reference to the drawings.

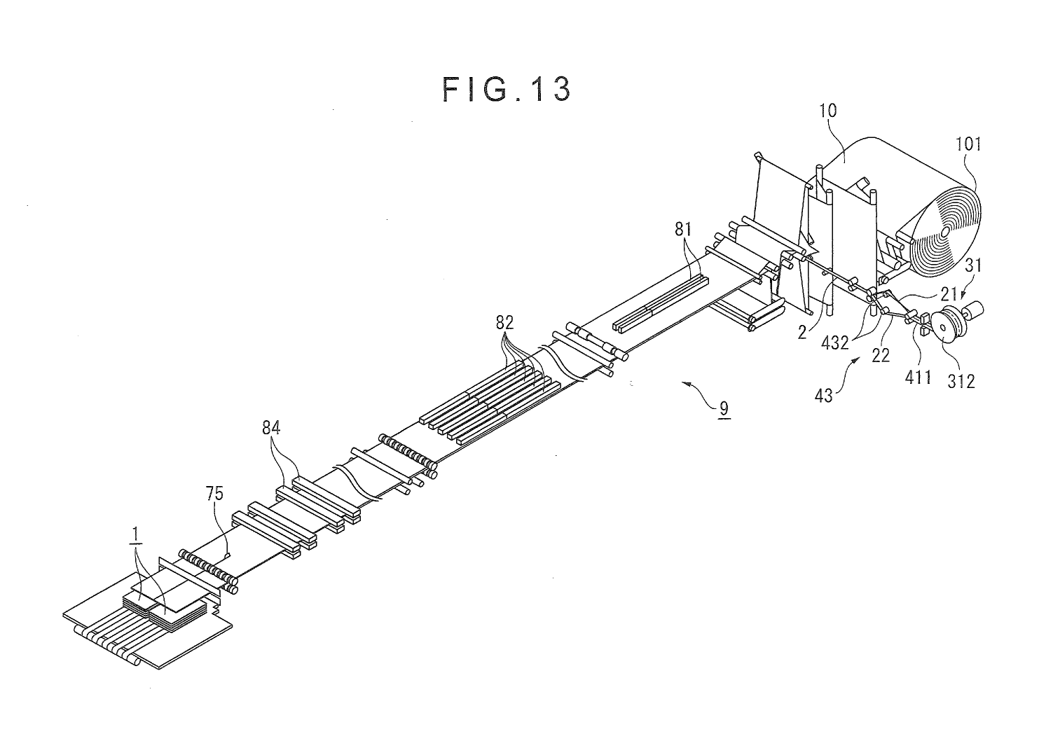

FIG. 13 is a perspective view showing a production device of the packaging bag according to the fifth exemplary embodiment.

In the fifth exemplary embodiment, the zipper tape 2 used in the three-side-sealing production device 9 according to the first exemplary embodiment is provided using the separator 43 that tears the zipper tape member 411 according to the third exemplary embodiment in half in the width direction.

In the fifth exemplary embodiment, the same or similar components as those in the above embodiments are denoted by the same reference symbols and the descriptions thereof will be omitted or simplified.

With the arrangement of the fifth exemplary embodiment, the same advantages as the above exemplary embodiments can be attained.

### Modification

The scope of the invention is not limited to the above-described embodiments but also includes modifications and improvements as long as an object of the invention can be achieved.

When the packaging bags 1 and 3 are produced, the contents X are automatically fed in the packaging bags. However, the bag may be filled with the contents through the opening and the opening may be heat-sealed for sealing after making a bag with an opening at one side, or the opening may be sealed by a zipper tape, not by heat-sealing, as used in a duvet cover. In other words, the arrangement for making the bag may be changed depending on the contents to be fed.

The invention may be applicable to a three-side seal bag in which portions corresponding to the sides and the bottom of a packaging bag are heat-sealed, a three-side seal bag in which portions corresponding to the sides and the opening of a packaging bag are heat-sealed, or a packaging bag provided with a gusset on the sides or the bottom.

Various bag-making methods are applicable to the invention in addition to the vertical-pillow-bag-making method in the second and third exemplary embodiments, the rotary-drum method in the fourth exemplary embodiment and the three-side-bag-making method in the first and fifth exemplary embodiments.

Although the void portion 25 is formed by punching, any method such as cutting or thermal-crushing is applicable for forming the void portion 25 as long as the engagement portion can be removed.

The void portion 25 may be formed by removing only the engagement portion and leaving the belt-like base.

Although the zipper tape members 311 and 411 each are separated into the male belt-like member 21 and the female belt-like member 22 after the void portion 25 is formed on the female belt-like member 22 of each of the zipper tape members 311 and 411, the void portion 25 may be formed only on the female belt-like member 22 after the zipper tape members 311 and 411 each are separated into the male belt-like member 21 and the female belt-like member 22.

Although the arrangement of each of the zipper tape members 311 and 411 is exemplified by the arrangement in which the male engagement portion 21A and the female engagement portion 22A are juxtaposed on a surface (the same surface) in the width direction of each of the zipper tape members 311 and 411, the male engagement portion 21A and the female engagement portion 22A may be respectively provided on both surfaces (different surfaces) in the width direction.

With this arrangement, there is no need to invert the male engagement portion 21A and the female engagement portion 22A to face each other after the zipper tape members 311 and 411 are separated.

In the fourth exemplary embodiment, the arrangement with the bendable member 24 is used. However, in addition to this arrangement, an arrangement in which an end of the male belt-like base 21B and an end of the female belt-like base 22B are brought substantially in contact with each other to be introduced may be applicable. With this arrangement, the male belt-like base 21B and the female belt-like base 22B can be easily positioned without the bendable member 24 and secure re-engagement is easily obtainable after opening.

The void portion 25 is also provided only on the female belt-like member 22 in this arrangement.

Other specific arrangements and shapes for carrying out the invention may be altered as long as an object of the invention is achieved.

1. A zipper tape comprising:
a male belt-like member having a male engagement portion;
a female belt-like member having a female engagement portion engageable with the male engagement portion; and
a void portion formed only on the female belt-like member at a predetermined interval in a longitudinal direction, the void portion being formed by removing the female engagement portion from the female belt-like member.

2. The zipper tape according to claim 1, wherein
the void portion is formed by punching.

3. A packaging bag provided with a zipper tape, comprising:
a packaging-bag film; and
the zipper tape according to claim 1 that is attached to the packaging-bag film, wherein
the packaging-bag film is superposed on each other and is thermally welded to each other at the void portion of the zipper tape in a direction intersecting a longitudinal direction of the zipper tape.

4. A method for producing a packaging bag provided with a zipper tape comprising a male belt-like member having a male engagement portion and a female belt-like member having a female engagement portion engageable with the male engagement portion, the packaging bag being provided by attaching the zipper tape on a packaging-bag film,
the method comprising:
forming a void portion only on the female belt-like member of the zipper tape at a predetermined interval in a longitudinal direction by removing the female engagement portion from the female belt-like member;
thermally welding the zipper tape having the void portion on the packaging-bag film; and
superposing the packaging bag on each other and thermally welding the superposed packaging bag to each other at the void portion of the zipper tape in a direction intersecting a longitudinal direction of the zipper tape.

5. A production device for a packaging bag provided with a zipper tape comprising a male belt-like member having a male engagement portion and a female belt-like member having a female engagement portion engageable with the male engagement portion, the packaging bag being provided by attaching the zipper tape on a packaging-bag film,
the production device comprising:
a void-portion forming unit that is configured to form a void portion only on the female belt-like member of the zipper tape at a predetermined interval in a longitudinal direction by removing the female engagement portion from the female belt-like member;
a zipper tape attaching unit that is configured to thermally weld the zipper tape having the void portion on the packaging-bag film; and
a side-seal forming unit that is configured to superpose the packaging-bag film on each other and thermally weld the superposed packaging-bag film to each other at the void portion of the zipper tape in a direction intersecting a longitudinal direction of the zipper tape.
